(19) United States
(12) Patent Application Publication
(10) Pub. No.: US 2006/0107662 A1
(43) Pub. Date: May 25, 2006

(54) INTERNAL COMBUSTION ENGINE WITH TURBO CHARGER AND DEVICE FOR INFLUENCING THE BOOST PRESSURE OF THE TURBO CHARGER AT LOW REVS

(75) Inventors: Mats Warmstrom, Landvetter (SE); Lennarth Zander, Stockholm (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/162,063

(22) Filed: Aug. 26, 2005

Related U.S. Application Data
(63) Continuation of application No. PCT/SE04/00217, filed on Feb. 18, 2004.

(30) Foreign Application Priority Data
Feb. 27, 2003 (SE) 0300569-1

(51) Int. Cl. F02B 33/44

(52) U.S. Cl. 60/605.2

(57) ABSTRACT

An internal combustion engine arrangement (10) for a vehicle with a turbo charger (16) and configured for influencing the boost pressure of the turbo charger at low engine speeds. The arrangement includes a tank (32) for storing a pressure medium, a line (31) for supplying pressure medium to the turbo charger and a valve (30) for controlling the supply of pressure medium. The line (31) connects to a mouthpiece (33) directed toward the impeller of the turbo charger (16). A pipe line (23) is connected to the exhaust-gas line (16) and the inlet line (20) enabling the recirculation of exhaust gas from the exhaust-gas line to the inlet line.

### CROSS-REFERENCE TO RELATED APPLICATIONS

The present application is a continuation patent application of International Application No PCT/SE2004/000217 filed 18 Feb. 2004 which was published in English pursuant to Article 21(2) of the Patent Cooperation Treaty, and which claims priority to Swedish Application No. 0300569-1 filed 27 Feb. 2003. Said applications are expressly incorporated herein by reference in their entireties.

### FIELD OF THE INVENTION

The present invention relates to an internal combustion engine for a vehicle with a turbo charger and a device for influencing the boost pressure of the turbo charger at low revs (low engine speeds), and which device includes a tank for storing a pressure medium, a line for supplying pressure medium to the turbo charger and a valve for controlling the supply of pressure medium.

### BACKGROUND OF THE INVENTION

Turbocharged internal combustion engines are designed to utilize kinetic energy of the exhaust current to compress inlet air and hence increase the air quantity in the combustion chamber. This has the effect that the fuel quantity to the combustion chamber is able to be increased, thereby boosting the engine power.

In turbocharged diesel engines intended for use in such vehicles as trucks and buses, the starting torque from the engine is often somewhat inadequate. The reason for this is that a turbocharged engine functions as a suction motor at low revs. The fact that the engine has an initial acceleration phase corresponding to that of a suction motor means that the air quantity which is typical of a turbocharged diesel engine is not then forthcoming. This, in turn, has the effect that the quantity of injected fuel to the engine has to be limited at low revs in order to minimize smoke production which would otherwise occur until the turbo charger is able to deliver an air quantity that allows for increased fuel quantity.

The abovementioned process is not advantageous because it contributes to worsened performance during startup (launch) of the vehicle from standstill (stationary). Furthermore, the engine feels “inadequate” to passengers during startup since the quantity of supplied fuel has necessarily had to be limited during the introductory suction-motor-like phase. On buses, the charge-air cooler connected to the inlet line is usually placed, for installation reasons, differently than on trucks; this means that pipelines are made longer, leading to an increased time interval for the introductory suction-motor-like phase.

The use of devices to improve acceleration properties for vehicles with turbo-charged engines is known from such documents as U.S. Pat. No. 5,461,860. Examples of such systems include arrangements that have a pressure medium storage tank, a line for supplying the pressure medium to the compressor side of a turbo charger and a valve for regulating the pressure medium supply.

A problem with using these known devices on diesel engines is that it is difficult to prevent pressure pulsations occurring in the inlet pipe upon activation because the diesel engine has no throttle valve in the inlet pipe. These pressure pulsations cause the electronic control unit of the engine to receive disturbed input data which usually results in control signals that severely limit the power takeoff of the engine; therefore, such known devices have not provided adequate solutions to the outlined deficiencies of the presently available systems.

### SUMMARY OF THE INVENTION

One object of the invention is therefore to produce an improved device pertaining to an internal combustion engine provided with a turbo charger, in which the turbo power can enter rapidly into force without the aforementioned problems. This object is achieved with the aid of a device of the type stated in the introduction, whose characterizing distinctive features can be derived from the following patent claim 1. One advantage with the device according to the invention is that the supply of pressure medium to the exhaust system has the effect of facilitating the transfer of EGR-gases from the exhaust side of the engine to the inlet side, which is otherwise a problem in turbo-charged diesel engines.

### BRIEF DESCRIPTION OF THE DRAWINGS

The invention will be described in greater detail below with reference to the illustrative embodiment shown in the appended drawing, which takes the form of a diagrammatic illustration of an internal combustion engine having a device configured according to the teachings of the present invention.

### DETAILED DESCRIPTION

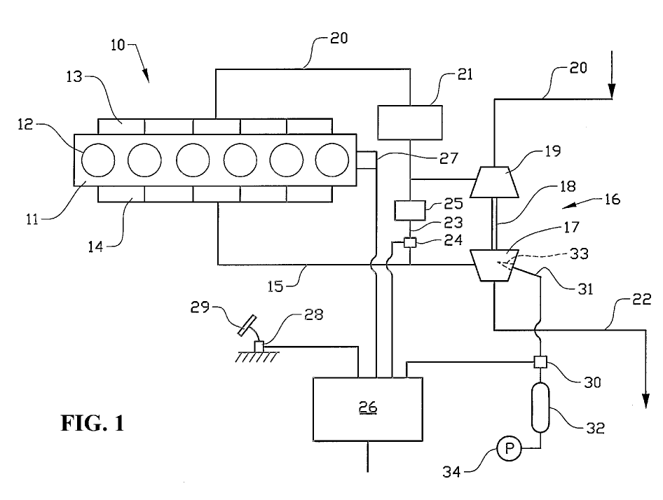

The internal combustion engine arrangement 10 shown in FIG. 1 comprises (includes, but is not necessarily limited to) an engine block 11 having six piston cylinders 12 with an inlet manifold 13 and an exhaust manifold 14. Exhaust gases are conducted via an exhaust-gas line 15 to the impeller 17 of a turbo charger 16. The turbine shaft 18 drives the impeller 19 of the turbo charger, which compresses incoming air delivered by an intake line 20 and transmits that air, via a charge-air cooler 21, to the inlet manifold 13. Fuel is fed to the respective cylinder 12 via injection devices (not shown). Although FIG. 1 illustrates a six-cylinder engine 10, the invention can also be utilized in connection with other cylinder configurations.

Exhaust gases which have passed through the turbo charger 16 are relayed to the atmosphere via the exhaust-gas line 22, which can conduct exhaust gases to exhaust after-treatment equipment or directly into the atmosphere. In addition, exhaust gases can be led back to the intake side of the engine as so-called EGR-gas, via a pipeline 23, in order to reduce nitrogen oxide emissions from the engine. This line comprises a valve 24 which serves both as a one-way valve and as a governor valve for regulating the EGR-flow. In addition, there is a cooler 25 for the cooling of EGR-gases. The invention is not limited, however, to engines with an EGR-function.

The valve 24 is connected to an engine control unit 26 containing control program and control data for controlling the engine with regard to input data. The engine control unit 26 is connected, for example, to a sensor 27, which senses the engine speed, and a sensor 28, which senses the position of the throttle controls 29. The engine control unit 26 is additionally connected to an electropneumatic governor valve 30, which is placed in a pipe line 31 extending between the turbine part 17 of the turbo charger and a tank 32 for storing pressure medium. The pipe line 31 herein connects to a mouthpiece 33 directed substantially tangentially inward toward the impeller. The tank 32 is loaded with pressure medium, for example air, by means of a compressor 34, which can be constituted, for example, by the brake-air compressor of the vehicle.

The engine control unit 26 is designed to control the governor valve 30, following the occurrence of certain operating parameters, to deliver compressed air to the impeller. For example, compressed air can be delivered whenever the sensor 28 detects maximum throttle. It is also possible to add further conditions for activating this function, for example that the fuel supply to the engine is throttled owing to unfavorable smoke formation in the exhaust gases and/or that the speed of the vehicle falls below a certain value. The invention should not be considered to be limited to the illustrative embodiments described above. Instead, a number of further variants and modifications are conceivable while still being within the scope of the patent claims.

What is claimed is:

1. An internal combustion engine arrangement for utilization in a vehicle and having a turbo charger (16), said arrangement (10) being configured for influencing the boost pressure of the turbo charger at low revs, said arrangement comprising:
an internal combustion engine (10) having a turbo charger (16);
a tank (32) for storing a pressure medium;
a line (31) for supplying pressure medium to the turbo charger (16) and a valve (30) for controlling the supply of pressure medium, said line (31) being connected to a mouthpiece (33) directed toward an impeller of the turbo charger (16);
an exhaust-gas line (15) extending between the turbo charger (16) and an exhaust manifold (14) and an inlet line (20) extending between the turbo charger (16) and an inlet manifold (13); and
a pipe line (23) connecting the exhaust-gas line to the inlet line and enabling the recirculation of exhaust gas from the exhaust-gas line to the inlet line.

2. The internal combustion engine as recited in claim 1, wherein the pipe line (23) is provided with a valve (24) for regulating the quantity of recirculated exhaust gas.

3. The internal combustion engine as recited in claim 1, wherein the pipe line (23) is provided with a cooler (25) for the cooling of recirculated exhaust gas.

4. The internal combustion engine as recited in claim 1, wherein the valve (30) is an electro-pneumatic valve.

5. The internal combustion engine as recited in claim 4, wherein the valve (30) is electrically connected to an engine control unit (26) for controlling the working parameters of the engine.

6. The internal combustion engine as recited in claim 5, wherein the engine control unit (26) is arranged to activate the valve (30) at maximum throttle.

7. The internal combustion engine as recited in claim 6, wherein the engine control unit (26) is arranged to activate the valve (30) at maximum throttle while at the same time the fuel supply is throttled by the engine control unit and the speed of the vehicle falls below a certain value.

8. The internal combustion engine as recited in claim 5, wherein the engine control unit (26) is arranged to activate the valve (30) at maximum throttle while at the same time the fuel supply is throttled by the engine control unit thereby avoiding unfavorable smoke formation in the exhaust gases of the engine.

9. The internal combustion engine as recited in claim 8, wherein the engine control unit (26) is arranged to activate the valve (30) at maximum throttle while at the same time the fuel supply is throttled by the engine control unit and the speed of the vehicle falls below a certain value.
